(19) United States
(12) Patent Application Publication
(10) Pub. No.: US 2019/0086527 A1
(43) Pub. Date: Mar. 21, 2019

(54) System and Method for Automatic Control of Radar Wave Emission

(71) Applicant: SPAWAR Systems Center Pacific, San Diego, CA (US)

(72) Inventors: Jacoby Larson, Surprise, AZ (US); Darren Powell, San Diego, CA (US)

(73) Assignee: United States of America as represented by Secretary of the Navy, San Diego, CA (US)

(21) Appl. No.: 15/708,985

(22) Filed: Sep. 19, 2017

(51) Int. Cl. G01S 13/02; G01S 7/02; G01S 7/03

(52) U.S. Cl. CPC G01S 13/02; G01S 2013/9082; G01S 7/03; G01S 7/023

(57) ABSTRACT

A method and system which enable the automatic activation and/or deactivation of the emission of radar wave signals from a radar system having a continuous rotating radar antenna. The automatic activation and/or deactivation of the emission of radar wave signal is controlled by a controller integrated with the radar system and is based on the bearing of the emitting antenna. The method relies on continuously reading the angular position of the antenna and allowing the flow of the electromagnetic wave frequency alternating current from the radar system's transmitter to the antenna only while the angle of the antenna is within a desired range. In some embodiments, the method and system may be provided with the desired range while in others, the method and system is operative to calculate the desired ranged based on the position and movement of the radar system relative to the position of a known target.

### STATEMENT OF GOVERNMENT INTEREST FEDERALLY SPONSORED RESEARCH AND DEVELOPMENT

The United States Government has ownership rights in this invention. Licensing inquiries may be directed to Office of Research and Technical Applications, Space and Naval Warfare Systems Center, Pacific, Code 72120, San Diego, Calif. 92152; telephone (619) 553-5118; email: ssc_pac_t2@navy.mil. Reference Navy Case No. 103,512.

### BACKGROUND OF THE INVENTION

### Field of the Invention

This invention relates generally to radar wave emissions and, more particularly, to automatic control of radar wave emissions.

### Description of the Prior Art

The operation and use of radar systems which utilize electromagnetic wave emissions to determine the range, angle, or velocity of objects is well established. Radar systems will typically include a transmitter, one or multiple antennas, a receiver and processor. The transmitter works with the antennas to produce electromagnetic waves. The receiver works with the antennas to receive electromagnetic waves which have been reflected off object(s). The processor works with the output of the receiver to determine properties such as location and speed of the object(s) from which the electromagnetic waves were deflected. In many embodiments, radar systems employ electromagnetic waves in the radio or microwave domain (referred to generally herein as “radar waves” or “wave signals”).

In many implementations, radar systems employ an antenna that rotates three hundred sixty degrees (360°) and generates a continuous stream of active wave signals. In such implementations, active wave signal generation is often controlled by a hardware or software switch. In cases wherein it has been desired to selectively shut off active wave signal generation, it typically has been done manually.

As such, a problem which still exists is that in a typical implementation of radar system with a continually rotating antenna, it may be impossible to automatically control the active wave signal generation based on the antenna's real time bearing so as to control the active illumination of the radar wave. It is well known that standard radar sweeps enable listening stations to detect and calculate the exact location of a platform emitting radar waves, which is an undesirable effect when attempting to operate covertly. For example, surface-to-air missile operators have historically learned to turn off their radar when an anti-radiation missile was being fired at them, and turn it back on later. These operators have shut off the radar by hand, and thus reduced the amount of data the other party could acquire. These operators, however could not continue their mission while they were trying to remain stealthy.

In addition, it is well known that interference noise can be created when radar waves intersect signals from another sensor or device on the same structure to which the radar system is attached (or a sensor or device adjacent thereto).

Thus, there remains a need for a system and method which automatically activates and deactivates through a software application the emitted wave signals on a continuously rotating radar antenna based on the bearing of the antenna, thereby providing more stealth and enabling the concept of masking to reduce interference noise.

### SUMMARY OF THE INVENTION

The present disclosure describes a system and method for automatic control of radar wave emissions from a rotating antenna based on the real time angular position of the rotating antenna. In accordance with one embodiment of the present disclosure, a method is provided for automatic control of radar wave emission from an antenna. The method includes: providing a radar system having a rotating antenna and a transmitter; receiving by a controller integrated with the radar system an encoder input which identifies a real time rotation angle of the rotating antenna; comparing the real time rotation angle of the rotating antenna to at least one of a desired target rotation angle and a target rotation angle range; and causing by the controller at least one of an active emission of electromagnetic waves from the rotating antenna to stop and an inactive emission of electromagnetic waves from the antenna to commence.

### BRIEF DESCRIPTION OF THE DRAWINGS

FIG. 1 shows the components of a radar system employing a system and method for automatic control of radar emissions in accordance with the present invention.

FIG. 2 shows the process through which an automatic control of radar emissions system and method in accordance with the present invention activates a wave signal only when the angle of an antenna of the radar system is in a target range.

FIG. 3 shows the process through which an automatic control of radar emissions system and method in accordance with the present invention deactivates an ongoing wave signal whenever the angle of an antenna of the radar system is outside of a target range.

FIG. 4 shows the process through which an automatic control of radar emissions system and method in accordance with the present invention determines a target angle range.

### DETAILED DESCRIPTION OF THE INVENTION

Applicant's invention described herein provides a method and system which enable the automatic activation and/or deactivation of the emission of radar wave signals from a radar system having a continuous rotating radar antenna. Current radar hardware usually spins continuously three hundred and sixty (360) degrees as it actively generates wave signals, which are large bursts of electromagnetic waves. There is currently no automatic method to turn the active radiation on and off at discrete angles for precise targeted detection. The instant invention allows for automatic activation and deactivation of the wave signals for sub-second intervals for specific discrete angles. This allows the radar to acquire information but still be stealthy.

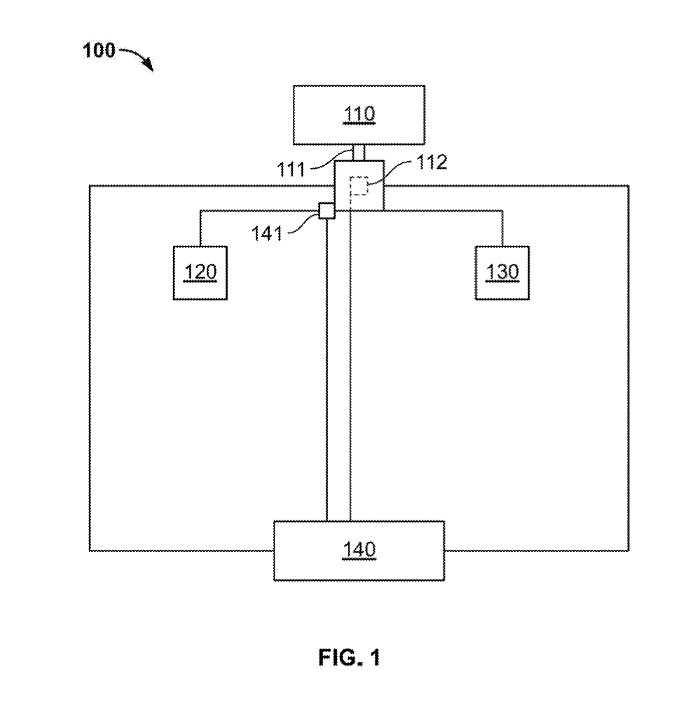

Referring now to FIG. 1, the primary components of a radar system 100 having automatic control of radar wave emissions is shown having an continuous rotating radar antenna 110 that includes a shaft 111, rotary encoder 112, transmitter 120, a receiver 130, a controller 140, and a control switch 141. It is appreciated that the antenna 110, transmitter 120, and receiver 130 are generally arranged and connected as with traditional radar systems, except for the inclusion of the control switch 141 in the connection between the transmitter 120 and the antenna 110. The control switch 141 defines a conventional electrical switch which operates to selectively close or open the electrical connection between the transmitter 120 and the antenna 110 in response to an input signal. In this regard, while the transmitter 120 may continuously generate an electromagnetic wave frequency alternating current that is suitable to cause the antenna 110 to produce electromagnetic waves, the antenna 110 will only receive this alternating current and produce radar waves when the control switch 141 is closed.

The control switch 141 is operatively connected to the controller 140 so as to allow the controller 140 to send electrical signals to the control switch 141 which may be used by the control switch 141 as input signals. The controller 140 is also electrically connected to the rotary encoder 112 which is integrated with the shaft 111 of the antenna 110 and operative to convert the angular position or motion of the shaft 111, as a reflection of the rotation angle of the antenna, to an analog or digital signal. The controller 140 includes one or more software applications contained thereon or otherwise accessible thereto which enable it to compare the angular position of the shaft 111, as provided by the rotary encoder 112, to a reference angle or angle range that has been provided to or calculated by the controller 140, and, based on the comparison, send an electrical signal to the control switch 141 that causes the control switch 141 to close or open the connection between the transmitter 120 and the antenna 110. In this regard, the controller 140 is operative to control when and if the antenna 110 receives the alternating current from the transmitter 120 and thus produces radar waves.

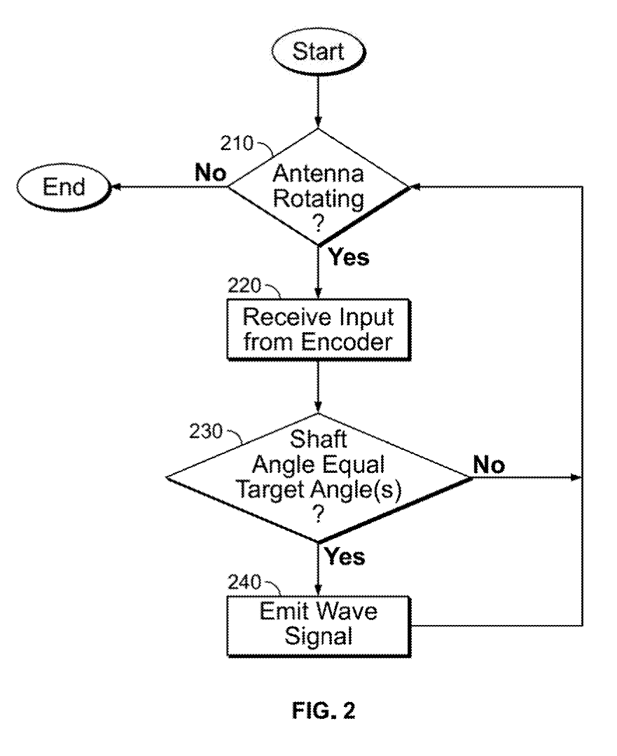

Referring now to FIG. 2, an embodiment of the automatic control of radar wave emission method causes radar waves to be emitted only when the antenna is at a specified angle (or in a specified range). Such an embodiment operates on a radar system with a rotating antenna and thus contemplates at step 210 of the antenna of the radar system rotating. Provided the antenna is rotating, a controller employed by the automatic control of radar wave emission method receives, at step 220, an input from a rotary encoder which defines the real time angular position of antenna. The controller then compares, at step 230, the angular position of the antenna to a target angle. It is contemplated that the target angle may be provided to the controller in advance or, as discussed below, calculated in real time by the controller. If the angular position of the antenna is equal to the target angle (or within a target range), the controller sends a signal, at step 240, to a control switch that is integrated with the transmitter and antenna of the radar system. The signal causes the control switch to close the (previously open) electrical connection between the transmitter and antenna. It is appreciated that by closing the electrical connection between the transmitter and antenna, the antenna will generate radar waves from the transmitter's alternating current.

If the angular position of the antenna is not equal to the target angle (or not within a target range), the controller again receives at step 220 an input from the rotary encoder which defines the real time angular position of antenna (provided the antenna is still rotating). When the antenna is no longer rotating, however, the process ends. It is contemplated that while the antenna is rotating, the controller will receive the real time angular position of antenna from the encoder in sub-second intervals.

In an embodiment of the process illustrated by FIG. 2, the control switch may operate as a momentary switch which only closes while receiving a signal from the controller.

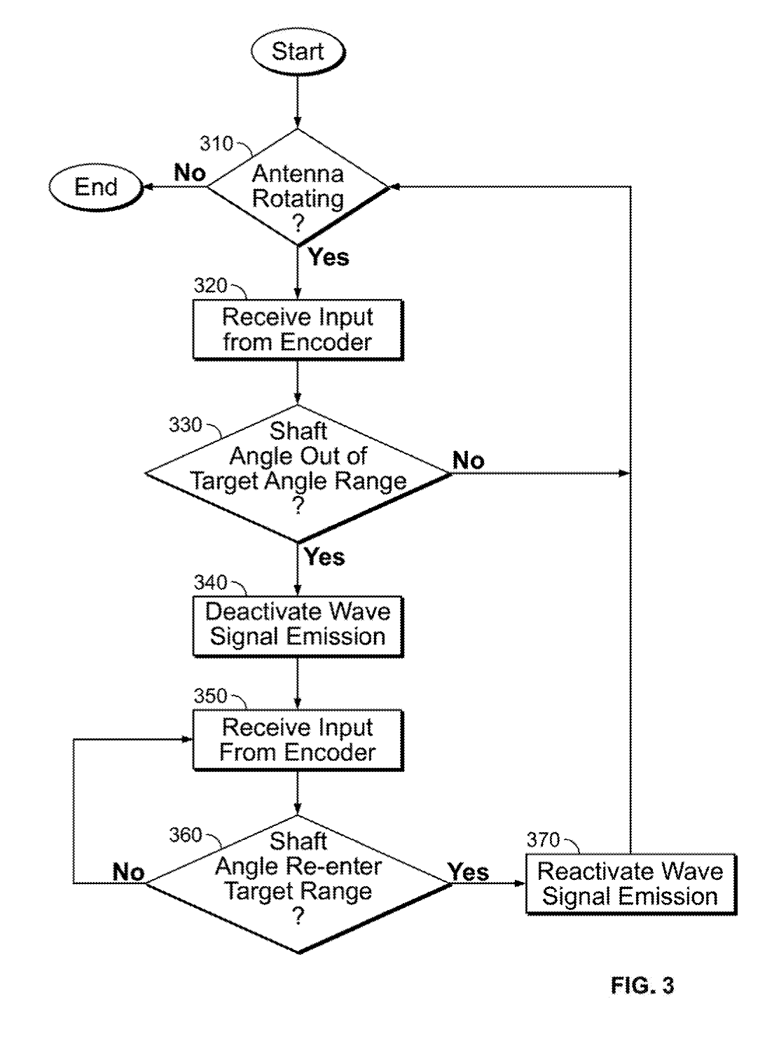

Referring now to FIG. 3, in an embodiment of the automatic control of radar wave emission method, radar waves are prevented from being emitted when the antenna is outside of a specified angle range. Such an embodiment operates on a radar system with a rotating antenna and thus contemplates at step 310 that the antenna of the radar system is rotating. Provided the antenna is rotating, a controller employed by the automatic control of radar wave emission method receives, at step 320, an input from a rotary encoder which defines the real time angular position of the antenna. The controller then compares, at step 330, the angular position of the antenna to a target angle range. It is contemplated that the target angle range may be provided to the controller in advance or, as discussed below, calculated in real time by the controller. If the angular position of the antenna is outside of the target angle range, the controller sends a signal, at step 340, to a control switch. The control switch is integrated with the transmitter and antenna of the radar system. The signal causes the control switch to open the (previously closed) electrical connection between the transmitter and antenna. It is appreciated that by opening the electrical connection between the transmitter and antenna, the antenna will no longer generate radar waves from the transmitter's alternating current.

With the control switch now open, the controller again receives, at step 350, an input from the rotary encoder which defines the real time angular position of antenna and then determines, at step 360, if the angular position of the antenna has re-entered the target angle range. If so, the controller sends a signal, at step 370, to the control switch. The signal causes the control switch to close the electrical connection between the transmitter and antenna, and thus reactivate the antenna's generation of radar waves from the transmitter's alternating current. If not, the controller will continue to receive, at step 350, an input from the rotary encoder and determine, at step 360, if the angular position of the antenna has re-entered the target angle range.

If, at step 330, the angular position of the antenna is inside the target angle range, the controller again receives, at step 320, an input from the rotary encoder which defines the real time angular position of antenna (provided the antenna is still rotating). When the antenna is no longer rotating, however, the process ends. It is contemplated that while the antenna is rotating, the controller will receive the real time angular position of antenna from the encoder in sub-second intervals.

In an embodiment of the process illustrated by FIG. 3, the control switch may operate as a toggle switch which remains in an open or closed state until an input is received.

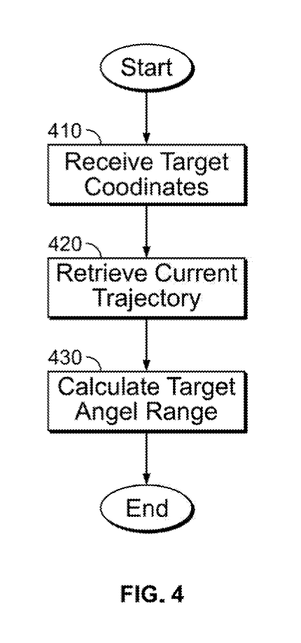

Referring now to FIG. 4, in some embodiments of the automatic control of radar wave emission method, the target angle range may be calculated by the controller from a set of coordinates which relate to the geospatial area in which it is desired emit radar waves or to avoid emitting radar waves. As such, the calculation of a target angle range begins with the controller receiving, at step 410, target geospatial coordinates. With the target geospatial coordinates, the controller then retrieves, at step 420, the position and trajectory of the radar system with which the controller is operating. The controller then calculates, at step 430, the target angle range based on a determination of which rotation angles of the antenna are directed into (or outside of) the target geospatial coordinates relative to the position and trajectory of the radar system.

It is contemplated that the calculation of the target angle range may be (1) performed in advance and based on a determination of which rotation angles of the antenna are directed into (or outside of) the target geospatial coordinates relative to a planned position and trajectory of the radar system, (2) performed in real time based on the target geospatial coordinates relative to a current position and trajectory of the radar system as determined by a geospatial positioning system, or (3) performed in advance with real time updates.

In one implementation, it is appreciated that the instant invention could be used in conjunction with the registration of radar returns and a priori coastlines, as described in U.S. Pat. No. 8,154,438, wherein only portions of the radar return are needed to perform accurate registration. The instant invention would allow the controller to determine the angles of active illumination needed for the registration algorithm and reduce the amount of active radiation on the rest of the coastline, thus preserving the possibility of radar detection by a receiver positioned on the coastline.

Another application would be to deactivate the radiation for the angles that are obstructed by other antennae or hardware on the same platform, to reduce noise levels in the returns of the proposed radar system as well as reduce noise in the returns of the obstructing sensors.

Yet another application is that the instant invention can be used to actively detect targets such as tracking an enemy contact for intelligence and reconnaissance or for determining relative position of other friendly vessels to be used for relative localization.

It will be understood that many additional changes in the details, materials, steps and arrangement of parts, which have been herein described and illustrated to explain the nature of the invention, may be made by those skilled in the art within the principle and scope of the invention as expressed in the appended claims.

What is claimed is:

1. A method for automatic control of radar wave emission from an antenna, comprising the steps of:
providing a radar system having a rotating antenna electrically connected to a transmitter such that the rotating antenna emits electromagnetic waves, while rotating, when an electromagnetic wave frequency alternating current generated by the transmitter is received;
receiving by a controller integrated with the radar system an encoder input which identifies a real time rotation angle of the rotating antenna;
comparing the real time rotation angle of the rotating antenna to at least one of a desired target rotation angle and a target rotation angle range; and
once the real time rotation angle equals the desired target rotation angle or is within the target rotation angle range, causing by the controller at least one of an active emission of electromagnetic waves from the rotating antenna to stop and an inactive emission of electromagnetic waves from the antenna to commence.

2. The method of claim 1, wherein the encoder input is received from a rotary encoder that is integrated with the rotating antenna.

3. The method of claim 1, wherein the step of causing is performed by sending an input signal to a control switch that is integrated with the rotating antenna and the transmitter and adapted to change a state of an electrical connection between the rotating antenna and the transmitter.

4. The method of claim 3, wherein the control switch is defined by a momentary switch.

5. The method of claim 3, wherein the control switch is defined by a toggle switch.

6. The method of claim 1, wherein the desired target rotation angle is calculated in real time by the controller.

7. The method of claim 1, wherein the desired target rotation angle range is calculated in real time by the controller.

8. The method of claim 1, wherein once the real time rotation angle equals the desired target rotation angle or is within the target rotation angle range, the controller causes an active emission of wave signals from the antenna to stop.

9. The method of claim 1, wherein once the real time rotation angle equals the desired target rotation angle or is within the target rotation angle range, the controller causes an inactive emission of wave signals from the antenna to commence.

10. A method for automatic control of radar wave emission from an antenna, comprising the steps of:
providing a radar system having a rotating antenna electrically connected to a transmitter such that the rotating antenna emits electromagnetic waves, while rotating, when an electromagnetic wave frequency alternating current generated by the transmitter is received;
receiving by a controller integrated with the radar system an encoder input which identifies a real time rotation angle of the rotating antenna, wherein the encoder input is received from a rotary encoder that is integrated with the rotating antenna;
comparing the real time rotation angle of the rotating antenna to at least one of a desired target rotation angle and a target rotation angle range; and
while the real time rotation angle equals the desired target rotation angle or is within the target rotation angle range, causing by the controller at least one of an active emission of electromagnetic waves from the rotating antenna to stop and an inactive emission of electromagnetic waves from the antenna to commence, wherein the step of causing is performed by sending an input signal to a control switch that is integrated with the rotating antenna and the transmitter and adapted to change a state of the electrical connection between the rotating antenna and the transmitter.

11. The method of claim 10, wherein the control switch is defined by a momentary switch.

12. The method of claim 10, wherein the control switch is defined by a toggle switch.

13. The method of claim 10, wherein the desired target rotation angle is calculated in real time by the controller.

14. The method of claim 10, wherein the desired target rotation angle range is calculated in real time by the controller.

15. The method of claim 10, wherein while the real time rotation angle equals the desired target rotation angle or is within the target rotation angle range, the controller causes an active emission of wave signals from the antenna to stop.

16. The method of claim 10, wherein while the real time rotation angle equals the desired target rotation angle or is within the target rotation angle range, the controller causes an inactive emission of wave signals from the antenna to commence.

17. A system having automatic control of radar wave emission from an antenna, comprising:
a radar system having a rotating antenna electrically connected to a transmitter such that the rotating antenna emits electromagnetic waves, while rotating, when an electromagnetic wave frequency alternating current generated by the transmitter is received;
a rotary encoder integrated with the rotating antenna and adapted to generate an encoder input which identifies a real time rotation angle of the rotating antenna;
a control switch that is integrated with the rotating antenna and the transmitter and adapted to change the state of the electrical connection between the rotating antenna and the transmitter;
a controller integrated with the radar system and connected to said rotary encoder and said control switch, wherein said controller is adapted to receive the encoder input and compare the encoder input to at least one of a desired target rotation angle and a target rotation angle range; and
wherein the controller is additionally adapted to cause at least one of an active emission of electromagnetic waves from the rotating antenna to stop and an inactive emission of electromagnetic waves from the antenna to commence if the real time rotation angle equals the desired target rotation angle or is within the target rotation angle range.

18. The system having automatic control of radar wave emission from an antenna of claim 17, wherein the at least one of the desired target rotation angle and the desired target rotation angle range is calculated in real time by the controller.

19. The system having automatic control of radar wave emission from an antenna of claim 17, wherein once the real time rotation angle equals the desired target rotation angle or is within the target rotation angle range, the controller causes an active emission of wave signals from the antenna to stop.

20. The system having automatic control of radar wave emission from an antenna of claim 17, wherein once the real time rotation angle equals the desired target rotation angle or is within the target rotation angle range, the controller causes an inactive emission of wave signals from the antenna to commence.
